(19) United States
(12) Patent Application Publication
(10) Pub. No.: US 2016/0150102 A1
(43) Pub. Date: May 26, 2016

(54) Mobile-First Photography Workflow Device

(71) Applicant: Adobe Systems Incorporated, San Jose, CA (US)

(72) Inventors: Andreas Wurf, Hamburg (DE); Torsten Sigwart, Hamburg (DE); Jens C. Neffe, Hamburg (DE)

(21) Appl. No.: 14/553,736

(22) Filed: Nov. 25, 2014

(51) Int. Cl. H04N 1/00; G06F 17/30; H04N 5/232

(52) U.S. Cl. CPC H04N 1/00209; H04N 1/00129; H04N 5/23229; H04N 5/23293; G06F 17/3028; H04N 2201/0084; H04N 2201/0039; H04N 2201/0049

(57) ABSTRACT

In embodiments of a mobile-first photography workflow device, digital photos that have been captured with a digital camera are received by the workflow device, and proxy images that each corresponds to one of the digital photos is created, where the proxy images have less data than a corresponding one of the digital photos, yet remain configured for photo editing. The proxy images are communicated to a tablet device that can receive and display a proxy image that has the less data than the corresponding digital photo. The workflow device can then receive a metadata update from the tablet device, where the metadata update is associated with a photographer editing a proxy image. An edited digital photo can then be generated at the workflow device based on the metadata update applied to the corresponding digital photo, and the edited digital photo can be synchronized with additional computing devices.

### BACKGROUND

Today's digital cameras, and particularly digital SLR (DSLR) cameras used by many professional and recreational photographers, capture digital photos that are often a data image as large as twenty to forty megapixels, resulting in photo data files that are several tens of megabytes in size. Manipulating and handling data of that size in a photographic workflow is expensive in terms of transfer bandwidth, processing time, and memory storage. Because of this, photographers that typically take a high-volume of photos at an event, such as at a sporting event or modeling show, or photographers that take a high-volume of photos over a lengthy vacation, need to carry at least a high-end notebook computer to handle the digital photo processing. These photographers also likely need to have available additional memory storage solutions, such as a hard disk device or a network-attached storage device to maintain the large photo data files.

Further, many photographers prefer a “mobile-first” workflow approach for at least initial photo previewing, sorting, and organizing before getting back to the office or home, and onto a computer device that is capable of handling the high-volume of photos and large photo data files. Typically, the professional photographers and vacation travelers prefer being able to perform initial image development, such as cropping images, making exposure adjustments, and applying presets on location and in the field, but without having to also carry along the type of larger and heavier computer device that would be capable of handling the processing and storage of large photo data files. As an alternative to carrying along a high-end notebook computer with the processing and memory capabilities, a photographer may typically carry a lighter, mobile tablet device. However tablet devices are not designed for the extensive importing, processing, and developing needed to accommodate the mobile-first workflow approach of handling large photo data files.

### SUMMARY

This Summary introduces features and concepts of a mobile-first photography workflow device, which is further described below in the Detailed Description and/or shown in the Figures. This Summary should not be considered to describe essential features of the claimed subject matter, nor used to determine or limit the scope of the claimed subject matter.

A mobile-first photography workflow device is described. In embodiments, digital photos that have been captured with a digital camera are received by the workflow device, and proxy images that each corresponds to one of the digital photos is created, where the proxy images have less data than a corresponding one of the digital photos, yet remain configured for photo editing. The proxy images are communicated to a tablet device that can receive and display a proxy image that has the less data than the corresponding digital photo. The workflow device can then receive a metadata update from the tablet device, where the metadata update is associated with a photographer editing a proxy image. An edited digital photo can then be generated at the workflow device based on the metadata update applied to the corresponding digital photo, and the metadata update can be synchronized with additional computing devices. The pixel data of a digital photo is preserved in the workflow device, and the edited digital photo is generated by replacing or altering the metadata that is associated with the digital photo.

In implementations, the workflow device can establish a communication link with the digital camera via which the digital photos are received, where the communication link is a wireless communication link or a cabled connection. Receiving the digital photos from the digital camera can be initiated automatically by the workflow device based on the communication link being established. The digital photos can be indexed and maintained in storage memory of the workflow device as an indexed backup of the digital photos. Additionally, metadata of the digital photos can be downloaded from the digital camera along with the digital photos, and a proxy image is generated in a Digital Negative (DNG) image format that includes the metadata of the corresponding digital photo. In addition to the proxy images, one or more image renditions can be generated from each of the digital photos, where the image renditions of a corresponding digital photo are generated without develop metadata that is associated with the digital photo.

### BRIEF DESCRIPTION OF THE DRAWINGS

Embodiments of a mobile-first photography workflow device are described with reference to the following Figures. The same numbers may be used throughout to reference like features and components that are shown in the Figures:

FIG. 1 illustrates an example system in which embodiments of a mobile-first photography workflow device can be implemented.

FIG. 2 further illustrates the example system in which embodiments of the mobile-first photography workflow device can be implemented.

FIG. 3 illustrates example methods of a mobile-first photography workflow device in accordance with one or more embodiments of the techniques described herein.

FIG. 4 illustrates example methods of a mobile-first photography workflow device in accordance with one or more embodiments of the techniques described herein.

FIG. 5 illustrates an example system with an example device that can implement embodiments of a mobile-first photography workflow device.

### DETAILED DESCRIPTION

Embodiments of a mobile-first photography workflow device are described, and the techniques described herein provide a photographer with a mobile photography workflow device that can be used in the field and on location of photo shoots to assist with digital photo processing and workflow. The workflow device is a portable combination of hardware and software that supports a mobile-first workflow for photographers for initial photo previewing, sorting, organizing, and image development, such as cropping images, making exposure adjustments, applying presets, and any other photo editing on location and in the field before getting back to a desktop or other computer device that has enough memory and processing power to sort and edit the digital photos.

In implementations, the workflow device enables use of a tablet device for the initial photo previewing and image development, where the workflow device performs as an image pre-processor to generate proxy images that are converted from digital photos to mediate between a camera and the tablet device. The workflow device also serves as a secure and complete backup of the original digital photos when downloaded from the camera, and synchronizes the digital photos, photos metadata, the proxy images, and/or other renditions of the digital photos between the workflow device, other computing and client devices, and cloud-based services.

While features and concepts of a mobile-first photography workflow device can be implemented in any number of different devices, systems, networks, environments, and/or configurations, embodiments of a mobile-first photography workflow device are described in the context of the following example devices, systems, and methods.

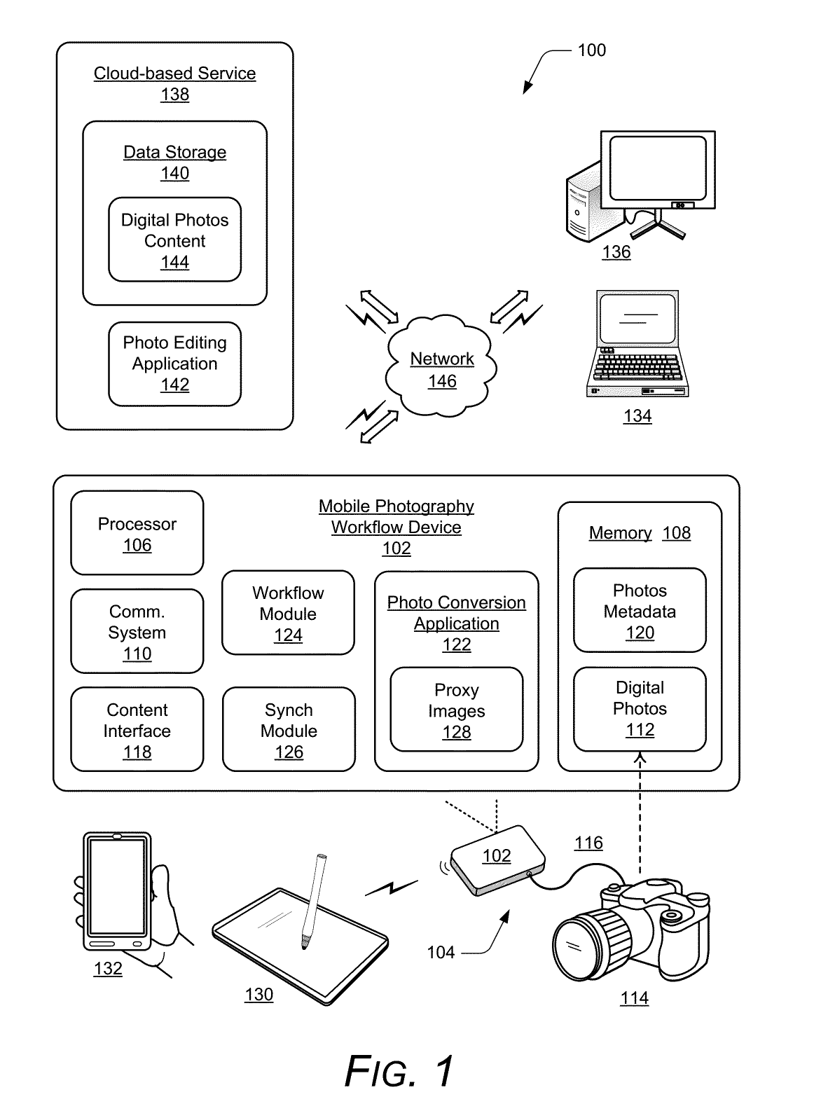

FIG. 1 illustrates an example system 100 in which embodiments of a mobile-first photography workflow device can be implemented. The example system 100 includes the mobile photography workflow device 102 (also referred to herein as the workflow device) that is implemented to provide a photographer with a mobile device that can be used in the field and on location of photo shoots to assist with digital photo processing and initial workflow. For example, a professional photographer on location who takes a lot of digital photos, or even a traveler on a lengthy vacation, can easily carry along and utilize the workflow device to facilitate initial mobile-first photo previewing, sorting, organizing, and image development on a tablet device.

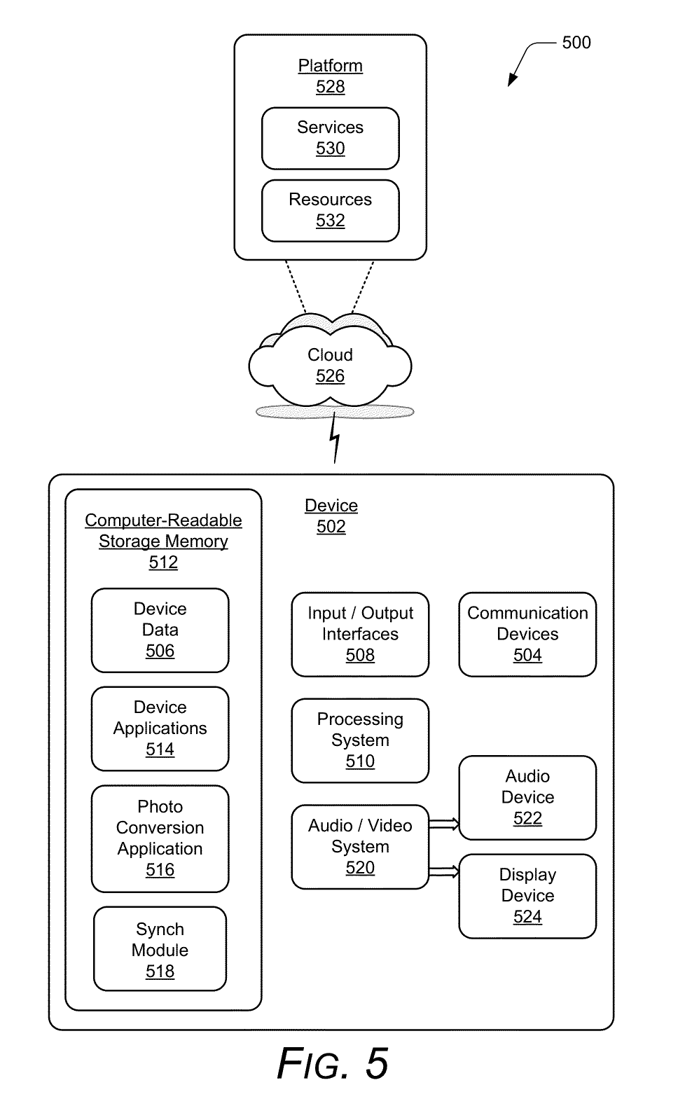

In this example, the workflow device 102 (also shown as a small form-factor device at 104) can be implemented with various components, such as a processor 106 (or a processing system) and a memory 108, as well as with any number and combination of differing components as further described with reference to the example device shown in FIG. 5. Generally, the memory 108 is implemented as a large capacity, solid-state memory device in the range of 400 gigabytes or more that can accommodate large photo data files. Although not shown, the workflow device 102 also includes a power source, such as a battery and/or a wired power source, to power device components.

The workflow device 102 can include different wireless radio systems, such as for Wi-Fi, Bluetooth™, Mobile Broadband, LTE, or any other wireless communication system or format. In this example, the workflow device 102 implements a communication system 110, which generally includes a radio device, antenna, and chipset that is implemented for wireless communication with other devices. For example, the communication system 110 may be implemented as a Wi-Fi radio system that can also be used as a Wi-Fi hotspot to facilitate wireless communication with other devices.

The workflow device 102 is implemented to download digital photos 112 from a memory or memory card of a camera 114, such as a digital SLR (DSLR) camera used by many professional and recreational photographers to capture the digital photos. A photo “captured” generally refers to the processing performed by a digital camera device to image a photo that a photographer has taken. The digital photos 112 may be downloaded from the camera 114 via a wireless communication link or via a cabled connection 116 through a content interface 118 of the workflow device. The content interface 118 may be implemented as a USB connector and interface, a memory card connector, or any other type of content interface via which digital content (e.g., the digital photos 112) is downloaded to the workflow device. Further, the workflow device 102 can be implemented to automatically initiate downloading the digital photos 112 from the camera when the camera is connected (e.g., wirelessly or via a cable connection) to the workflow device, and without user activation. This may be transparent to the photographer, who just sees that the images have been downloaded from the camera.

Additionally, photos metadata 120 of the digital photos 112 is downloaded from the camera 114 along with the digital photos. The photos metadata 120 can include both informal metadata and develop metadata. The informal metadata can include such data as copyright information, a caption, a title, a timestamp (e.g., date and time), location data corresponding to when and where a photo is captured, and any other information about a digital photo. The develop metadata is related to any type of image development, such as image cropping, exposure adjustments, and setting presets applied to a digital photo. The digital photos 112 and the associated photos metadata 120 are maintained in the memory 108 of the workflow device, which serves as secure and complete backup of the original digital photos when downloaded from the camera. The mobile-first photography workflow is a “non-destructive workflow”, meaning that the pixel data of an original digital photo 112 is immutable and preserved in the memory 108 of the workflow device 102 as the secure backup of the digital photo.

The workflow device 102 includes a photo conversion application 122 that can be implemented as a software application or module, such as executable software instructions (e.g., computer-executable instructions) that are executable with a processing system of the device to implement embodiments of the mobile-first photography workflow device. The photo conversion application 122 can be stored on computer-readable storage memory (e.g., the device memory 108), such as any suitable memory device or electronic data storage implemented by the workflow device. Similarly, the workflow device 102 includes a workflow module 124 and a synchronization module 126, both of which may be integrated as components of an operating system on the workflow device, or implemented independently as software modules on the device.

The photo conversion application 122 is implemented to create a proxy image 128 from each of the digital photos 112, where a proxy image, also referred to as a Digital Negative (DNG) or a “Smart Preview”, has a smaller file structure with less data than the corresponding digital photo (also referred to as the original, raw image). A Digital Negative (DNG) is a compact, lossy image format written by Adobe™ and used for digital photography. DNG is based on the TIFF/EP standard format, and a DNG file includes data for a digital photo 112, as well as the photos metadata 120, and optionally contains a JPEG preview image of the digital photo. A DNG file maintains the benefits of the original photo file, namely increased flexibility and artistic control, yet is smaller in size.

Further, a lossy DNG format provides an image format somewhere between an original photo file (that may be 25 MB) and a JPEG (that may be 6 MB), yet retains the flexibility for image development, such as for adjusting the white balance and preserving detail. In addition to the proxy images 128, the photo conversion application 122 can generate other image renditions, such as standard previews and thumbnails from the digital photos. Generally, the other image renditions are generated without the associated develop metadata, however, an image rendition may include some metadata, such as copyright information or other informal metadata.

The memory 108 maintains the digital photos 112 and the associated photos metadata 120, and can be utilized as an indexed image store to maintain the digital photos 112, the proxy images 128, and any other renditions (e.g., standard previews, thumbnails, etc.) of the digital photos. The workflow module 124 is application logic that can be implemented as a device manager of the workflow device 102, and manages user interaction with the device, such as via optional device input and output controls that may be utilized to initiate stand-alone operations and to visualize current device status. In this example implementation, the workflow device 102 does not include a display device or display screen, although in an alternate configuration, the workflow device may include an integrated display. Generally, a photographer can check current device status and other details, such as how much memory space is available, when the workflow device 102 is connected to the camera 114, such as viewed in the integrated display of the camera. The workflow module 124 may also manage updates of software and/or firmware on the workflow device, such as via Wi-Fi or when connected to a computer, and for new functionality and software updates, camera and lens profiles, personalized groups of adjustment settings, and the like.

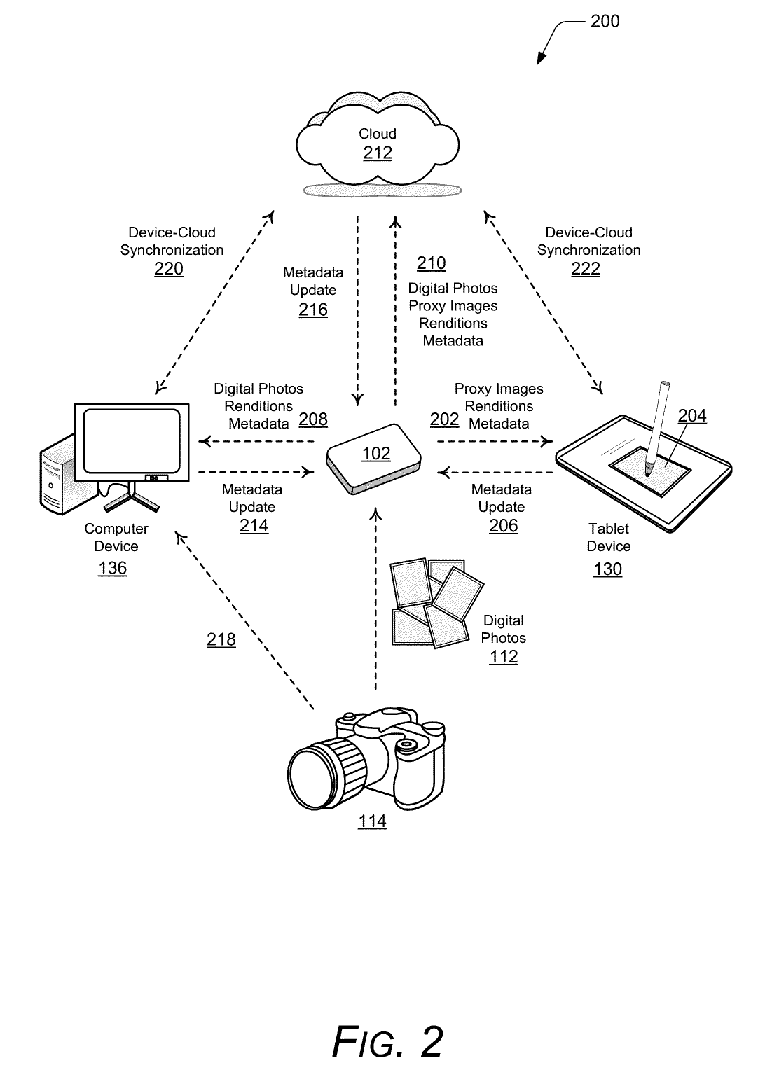

The synchronization module 126 is implemented to synchronize the digital photos 112, the photos metadata 120, the proxy images 128, and/or other renditions of the digital photos between the workflow device 102, cloud-based services, and other computing and client devices in the example system 100 that also implement the synchronization module. For example, the synchronization module 126 of the workflow device 102 can communicate and synchronize the proxy images 128 with a tablet device 130 or a mobile phone 132 that a photographer may carry along as a lightweight, mobile device for initial mobile-first photo previewing, sorting, organizing, and image development. In embodiments, the workflow device 102 brings the camera 114 and the tablet device 130 (or mobile phone 132) together, and performs as an image pre-processor to generate the proxy images 128 that are converted from the digital photos 112 to mediate between the camera and the tablet device or mobile phone. Aspects of synchronization between the devices and services are further shown and described with reference to FIG. 2.

The example system 100 also includes computer devices, such as a high-end notebook computer 134 or desktop computer 136, that a photographer may use once back at the office or at home for image processing, editing, and image development of the digital photos 112. The notebook computer 134 and the desktop computer 136 are examples of computing devices that are capable of processing and handling the high-volume of photos, as well as the large photo data files that can be generated with professional DSLR cameras. Unlike the tablet device 130 or the mobile phone 132 that receives the proxy images 128 and photos metadata 120 from the workflow device 102, but typically not the digital photos themselves, the synchronization module 126 of the workflow device can synchronize the digital photos 112, the photos metadata 120, the proxy images 128, and other renditions of the digital photos between the workflow device 102 and the computer devices.

The example system 100 also includes a cloud-based service 138 having data storage 140 and a photo editing application 142, such as Adobe Photoshop™ offered as a cloud-based application that a photographer can access via any type of the other devices, such as via the notebook computer 134 or the desktop computer 136. The synchronization module 126 of the workflow device 102 can also synchronize the digital photos 112, the photos metadata 120, the proxy images 128, and other renditions of the digital photos between the workflow device 102 and the cloud-based service that maintains all of the digital photos content 144 in the data storage 140.

The cloud-based service 138 is representative of any number of cloud-based access sites from which data, information, and applications are available, such as via the Internet, when posted to the Web, on an intranet site, on an external Web site, or any other similar location for on-line and/or network-based access. The cloud-based service 138 includes the data storage 140 (e.g., cloud data storage) that may be implemented as any suitable memory, memory device, or electronic data storage for network-based data storage. The cloud-based service 138 may include multiple server devices and applications, and can be implemented with various components, such as a processing system and memory, as well as with any number and combination of differing components as further described with reference to the example device shown in FIG. 5.

Any of the devices, servers, and/or services described herein can communicate via a network 146, such as for data communication between the mobile photography workflow device 102, the mobile devices (e.g., the tablet device 130 and the mobile phone 132), the computer devices (e.g., the notebook computer 134 and the desktop computer 136), and the cloud-based service 138. The network 146 can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

FIG. 2 further illustrates the example system shown in FIG. 1 and generally, the synchronization 200 of the digital photos content between the various devices and services. As noted above, all of the devices and services can implement the synchronization module 126 (e.g., the same synchronization protocol) to maintain and update the digital photos content between the devices and services. For example, the workflow device 102 is implemented to download the digital photos 112 from a memory or memory card of the camera 114, convert the digital photos 112 to the proxy images 128, and communicate the digital photos content 202 (e.g., the proxy images 128, the photos metadata 120, and optionally, other renditions) to the tablet device 130. A photographer may then sort through and organize the photos, in the format of the proxy images, as well as edit or apply image developments to a proxy image 204 that is displayed on the tablet device. The photo metadata 120 that is associated with the proxy image 204 can then be communicated back to the workflow device 102 as a metadata update 206, which may include updates to the informal metadata and/or updates to the develop metadata that is associated with the corresponding digital photo.

Similarly, the workflow device 102 can communicate the full data files for the original digital photos 112, the photos metadata 120, and optionally the proxy images 128 and/or other renditions as the digital photos content 208 to the computer device 136, or as the digital photos content 210 to the cloud 212 (e.g., representative of the cloud-based service 138). The cloud-based service 138 and the computer device 136 are capable of processing and handling a high-volume of photos, as well as the large photo data files of the digital photos 112 that can be generated with DSLR cameras. It should be noted that the metadata update 206 associated with any image developments performed by the photographer on the tablet device 130 are also synchronized as part of the digital photos content 208 that is communicated to the computer device 136, and is synchronized as part of the digital photos content 210 that is communicated to the cloud-based service.

Further, any image developments performed by the photographer on the digital photos 112 at the computer device 136 can be synchronized as the metadata update 214 back to the workflow device 102, which is then also synchronized again with the tablet device 130 and the cloud-based service. Additionally, any image developments performed by the photographer on the digital photos 112 with the photo editing application 142 at the cloud-based service 138 can be synchronized as the metadata update 216 back to the workflow device 102, which is then also synchronized again with the tablet device 130 and the computer device 136. Generally, the synchronization 200 of the digital photos content between the various devices and services can also include the digital photos content being uploaded directly to the computer device at 218 and/or uploaded to the cloud 212 via the network 146. Similarly, the computer device 136 may directly synchronize 220 with the cloud 212 to exchange the digital photos content, and the tablet device 130 may directly synchronize 222 with the cloud 212. The overall synchronization process assures that the workflow device 102, as well as the various devices and services, have the same updated photos metadata 120 for the digital photos 112.

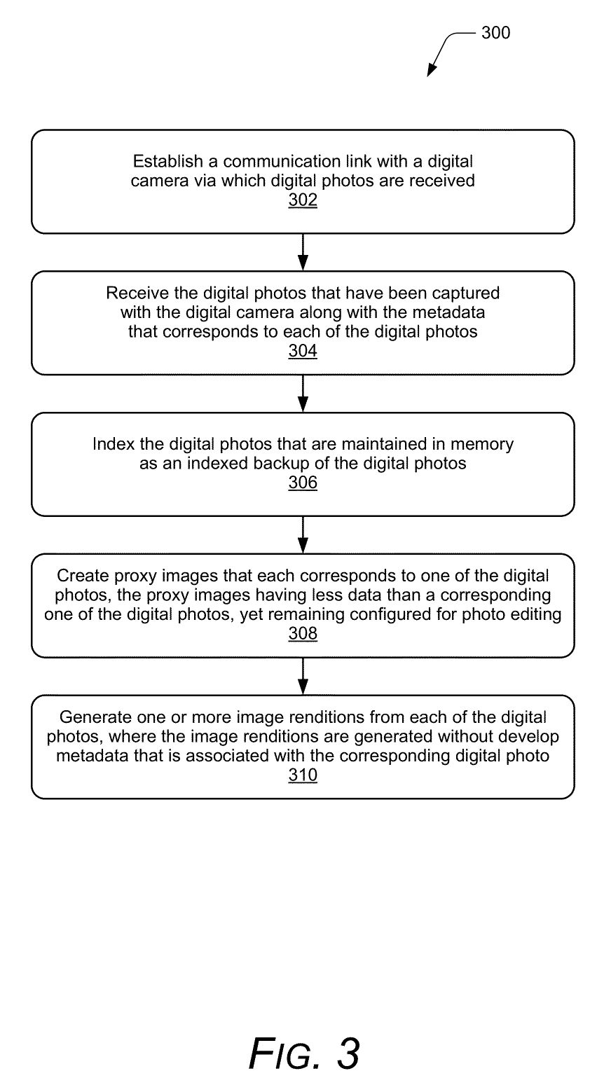

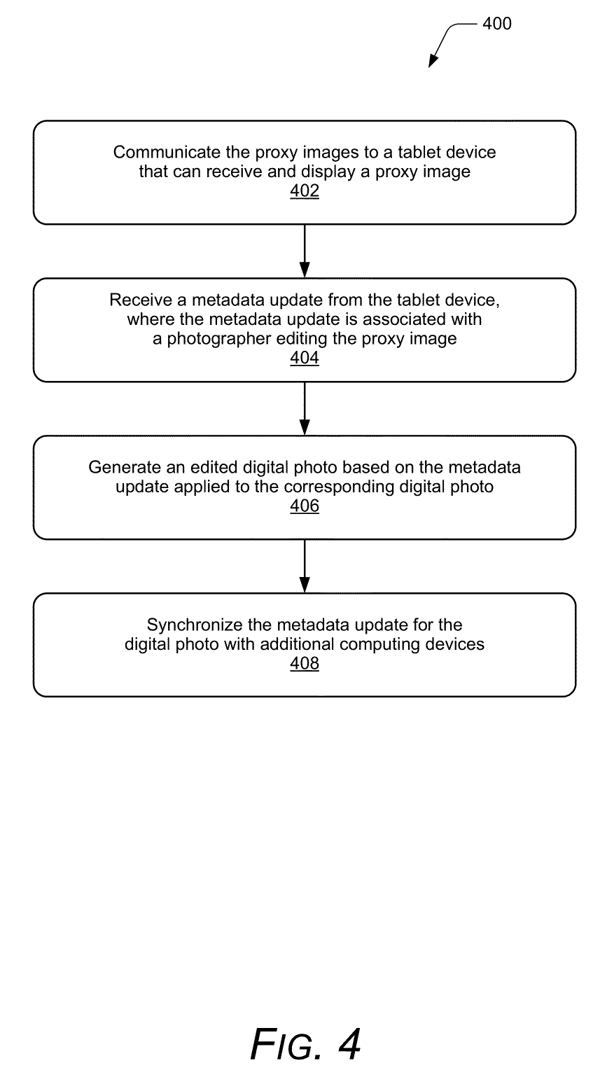

Example methods 300 and 400 are described with reference to respective FIGS. 3 and 4 in accordance with one or more embodiments of mobile-first photography workflow device. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of a mobile-first photography workflow device, and is generally described with reference to the workflow device shown in the example system of FIG. 1. The order in which the method is described is not intended to be construed as a limitation, and any number or combination of the method operations can be combined in any order to implement a method, or an alternate method.

At 302, a communication link is established with a digital camera via which digital photos are received. For example, the workflow device 102 establishes a communication link with the digital camera 114 via which the digital photos 112 are received, and the communication link can be a wireless communication link of the communication system 110 (e.g., a Wi-Fi wireless link) or the cabled connection 116.

At 304, the digital photos that have been captured with the digital camera are received along with the metadata that corresponds to each of the digital photos. For example, the workflow device 102 receives the digital photos 112 that are downloaded from the digital camera 114 along with the metadata 120 that corresponds to each of the digital photos, and receiving the digital photos 112 and the metadata 120 from the digital camera 114 can be initiated automatically by the workflow device 102 based on the communication link being established with the camera.

At 306, the digital photos are indexed and maintained in memory as an indexed backup of the digital photos. For example the workflow module 124 that is implemented by the workflow device 102 indexes the digital photos 112 that are maintained in the memory 108 of the workflow device 102 as an indexed backup of the digital photos, which serves as secure and complete backup of the original digital photos when downloaded from the camera.

At 308, proxy images that each corresponds to one of the digital photos are created, where the proxy images have less data than a corresponding one of the digital photos, yet remain configured for photo editing. For example, the photo conversion application 122 that is implemented by the workflow device 102 creates a corresponding proxy image 128 for each of the digital photos 112, and a proxy image 128 has less data than a corresponding one of the digital photos, yet remains configured for photo editing. In implementations, a proxy image 128 is a Digital Negative (DNG) image format that includes the metadata 120 of the corresponding digital photo 112.

At 310, one or more image renditions are generated from each of the digital photos, where the image renditions of a corresponding digital photo are generated without develop metadata that is associated with the digital photo. For example, the photo conversion application 122 also generates one or more image renditions (e.g., a standard preview and/or a thumbnail image) from each of the digital photos 112, and the image renditions of a corresponding digital photo are generated without the develop metadata that is associated with the digital photo. Although the image renditions are generated without the associated develop metadata, an image rendition may include some informal metadata. Further, the image renditions can be generated varying in image dimensions (e.g., size) and display quality.

FIG. 4 illustrates example method(s) 400 of a mobile-first photography workflow device, and is generally described with reference to the workflow device shown in the example system of FIG. 1. The order in which the method is described is not intended to be construed as a limitation, and any number or combination of the method operations can be combined in any order to implement a method, or an alternate method.

At 402, the proxy images are communicated to a tablet device that can receive and display a proxy image. For example, the workflow device 102 communicates the proxy images 128 to the tablet device 130 that can receive and display a proxy image 204 that has less data than the corresponding digital photo, where the tablet device 130 is generally not configured to handle and process the digital photos themselves. A photographer can then sort through and organize the photos, in the format of the proxy images, as well as edit or apply image developments to the proxy image 204 that is displayed on the tablet device.

At 404, a metadata update is received from the tablet device, where the metadata update is associated with a photographer editing the proxy image. For example, the photo metadata 120 that is associated with the proxy image 204 is communicated back to the workflow device 102 as the metadata update 206, which may include updates to the informal metadata and/or updates to the develop metadata that is associated with the corresponding digital photo, and the workflow device 102 receives the metadata update 206 from the tablet device 130.

At 406, an edited digital photo is generated based on the metadata update applied to the corresponding digital photo. For example the workflow module 124 that is implemented by the workflow device 102 generates an edited digital photo based on the metadata update 206 applied to the corresponding digital photo 112. The pixel data of the original digital photo 112 is immutable and preserved in the memory 108 of the workflow device 102 as a secure backup of the original digital photo. The edited digital photo is generated by replacing, enriching, or altering the metadata 120 that is associated with the original digital photo.

At 408, the metadata update is synchronized with additional computing devices. For example, the workflow device 102 synchronizes the digital photos content (e.g., the original digital photos 112, the photos metadata 120 and metadata updates, the proxy images 128, and/or other renditions of the digital photos) with the other devices and services. The workflow device 102 synchronizes the metadata update 206 associated with any image developments performed by the photographer on the tablet device 130 as part of the digital photos content 208 that is communicated to the computer device 136, and synchronizes the digital photos content 210 that is communicated to the cloud-based service 138 (e.g., represented as the cloud 212).

FIG. 5 illustrates an example system 500 that includes an example device 502, which can implement embodiments of a mobile-first photography workflow device. The example device 502 can be implemented as any of the computing devices and/or services (e.g., server devices) described with reference to the previous FIGS. 1-4, such as any type of computing device, client device, mobile phone, tablet, communication, entertainment, gaming, media playback, and/or other type of device. For example, the workflow device 102, tablet device 130, mobile phone 132, notebook computer 134, desktop computer 136, and/or server devices of the cloud-based service 138 shown in FIG. 1 may be implemented as the example device 502.

The device 502 includes communication devices 504 that enable wired and/or wireless communication of device data 506, such as digital photos, photos metadata, proxy images, and other photo renditions that are transferred, communicated, or synchronized from one device to another. Generally, the device data can include any type of audio, video, and/or image data, such as digital photos content (to include the metadata). The communication devices 504 can also include transceivers for cellular phone communication and/or for network data communication.

The device 502 also includes input/output (I/O) interfaces 508, such as data network interfaces that provide connection and/or communication links between the device, data networks, and other devices. The I/O interfaces can be used to couple the device to any type of components, peripherals, and/or accessory devices, such as a digital camera device that may be integrated with device 502. The I/O interfaces also include data input ports via which any type of data, media content, and/or inputs can be received, such as user inputs to the device, as well as any type of audio, video, and/or image data received from any content and/or data source.

The device 502 includes a processing system 510 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 502 may further include any type of a system bus or other data and command transfer system that couples the various components within the device. A system bus can include any one or combination of different bus structures and architectures, as well as control and data lines.

The device 502 also includes computer-readable storage memory 512, such as data storage devices that can be accessed by a computing device, and that provide persistent storage of data and executable instructions (e.g., software applications, modules, programs, functions, and the like). Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 512 provides storage of the device data 506 and various device applications 514, such as an operating system that is maintained as a software application with the computer-readable storage memory and executed by the processing system 510. In this example, the device applications also include a photo conversion application 516 and a synchronization module 518 that implements embodiments of the mobile-first photography workflow device, such as when the example device 502 is implemented as the workflow device 102 shown in FIG. 1. An example of the photo conversion application 516 includes the photo conversion application 122 that is implemented by the workflow device 102, and an example of the synchronization module 518 includes the synchronization module 126 that is implemented by the workflow device 102, as described with reference to FIGS. 1-4.

The device 502 also includes an audio and/or video system 520 that generates audio data for an audio device 522 and/or generates display data for a display device 524. The audio device and/or the display device include any devices that process, display, and/or otherwise render audio, video, display, and/or image data, such as the image content of a digital photo. In implementations, the audio device and/or the display device are integrated components of the example device 502. Alternatively, the audio device and/or the display device are external, peripheral components to the example device. In embodiments, at least part of the techniques described for mobile-first photography workflow device may be implemented in a distributed system, such as over a “cloud” 526 in a platform 528. The cloud 526 includes and/or is representative of the platform 528 for services 530 and/or resources 532. For example, the services 530 may include the cloud-based service 138 for photo editing as described with reference to FIGS. 1-4.

The platform 528 abstracts underlying functionality of hardware, such as server devices (e.g., included in the services 530) and/or software resources (e.g., included as the resources 532), and connects the example device 502 with other devices, servers, etc. The resources 532 may also include applications and/or data that can be utilized while computer processing is executed on servers that are remote from the example device 502. Additionally, the services 530 and/or the resources 532 may facilitate subscriber network services, such as over the Internet, a cellular network, or Wi-Fi network. The platform 528 may also serve to abstract and scale resources to service a demand for the resources 532 that are implemented via the platform, such as in an interconnected device embodiment with functionality distributed throughout the system 500. For example, the functionality may be implemented in part at the example device 502 as well as via the platform 528 that abstracts the functionality of the cloud 526.

Although embodiments of a mobile-first photography workflow device have been described in language specific to features and/or methods, the appended claims are not necessarily limited to the specific features or methods described. Rather, the specific features and methods are disclosed as example implementations of a mobile-first photography workflow device.

1. A method implemented by a mobile photography workflow device in a digital photography environment, the method comprising:
receiving digital photos that have been captured with a digital camera;
creating proxy images that each corresponds to one of the digital photos, the proxy images having less data than a corresponding one of the digital photos, yet remaining configured for photo editing;
communicating the proxy images to a tablet device that is configured to receive and display a proxy image that is less data than the corresponding digital photo;
receiving a metadata update from the tablet device, the metadata update associated with editing the proxy image; and
generating an edited digital photo based on the metadata update applied to the corresponding digital photo.

2. The method as recited in claim 1, wherein the proxy image is a Digital Negative (DNG) image format of the corresponding digital photo.

3. The method as recited in claim 1, further comprising:
receiving metadata of the digital photos downloaded from the digital camera, and wherein the proxy image includes the metadata of the corresponding digital photo.

4. The method as recited in claim 1, further comprising:
indexing the digital photos that are maintained in memory as an indexed backup of the digital photos.

5. The method as recited in claim 1, further comprising:
synchronizing the metadata update with one or more additional computing devices.

6. The method as recited in claim 1, further comprising:
generating one or more image renditions from each of the digital photos, the one or more image renditions of the corresponding digital photo generated without develop metadata that is associated with the corresponding digital photo.

7. The method as recited in claim 1, further comprising:
establishing a communication link with the digital camera via which the digital photos are received, the communication link configured as a wireless communication link or as a cabled connection; and
initiating automatically said receiving the digital photos from the digital camera based on the communication link being established.

8. A mobile photography workflow device, comprising:
an input interface configured to receive digital photos that have been captured with a digital camera;
a processor system configured to execute a photo conversion application that is implemented to create proxy images that each corresponds to one of the digital photos, the proxy images having less data than a corresponding one of the digital photos, yet remaining configured for photo editing;
the processor system further configured to execute a workflow module that is implemented to:
initiate communication of the proxy images to a mobile device that is configured to receive and display a proxy image, but not configured to process the digital photos;
receive a metadata update from the mobile device, the metadata update associated with editing the proxy image; and
generate an edited digital photo based on the metadata update applied to the corresponding digital photo.

9. The mobile photography workflow device as recited in claim 8, wherein the proxy image is a Digital Negative (DNG) image format of the corresponding digital photo.

10. The mobile photography workflow device as recited in claim 8, wherein the input interface is configured to receive metadata of the digital photos downloaded from the digital camera, and wherein the proxy image includes the metadata of the corresponding digital photo.

11. The mobile photography workflow device as recited in claim 8, further comprising a memory configured to maintain the digital photos as an indexed backup of the digital photos.

12. The mobile photography workflow device as recited in claim 8, wherein the workflow module is implemented to synchronize the metadata update with one or more additional computing devices.

13. The mobile photography workflow device as recited in claim 8, wherein the photo conversion application is implemented to generate one or more image renditions from each of the digital photos, the one or more image renditions of the corresponding digital photo generated without develop metadata that is associated with the corresponding digital photo.

14. The mobile photography workflow device as recited in claim 8, wherein the input interface includes a communication link that is one of:
a wireless communication link configured to wirelessly receive the digital photos downloaded from the digital camera; or
a cabled connection to the digital camera via which the digital photos are downloaded from the digital camera.

15. The mobile photography workflow device as recited in claim 14, wherein the workflow module is implemented to initiate an automatic download of the digital photos from the digital camera based on the communication link being established.

16. A computer-readable storage memory comprising stored instructions that are executable and, responsive to execution of the instructions by a processor system, a mobile photography workflow device performs operations comprising to:
receive digital photos that have been captured with a digital camera;
create proxy images that each corresponds to one of the digital photos, the proxy images having less data than a corresponding one of the digital photos;
communicate the proxy images to a tablet device that is configured to display a proxy image;
receive a metadata update from the tablet device, the metadata update associated with editing the proxy image; and
generate an edited digital photo based on the metadata update applied to the corresponding digital photo.

17. The computer-readable storage memory as recited in claim 16, wherein the mobile photography workflow device performs the operations further comprising to receive metadata of the digital photos downloaded from the digital camera, and wherein the proxy image is a Digital Negative (DNG) image format that includes the metadata of the corresponding digital photo.

18. The computer-readable storage memory as recited in claim 16, wherein the mobile photography workflow device performs the operations further comprising to index the digital photos that are maintained in memory as an indexed backup of the digital photos.

19. The computer-readable storage memory as recited in claim 16, wherein the mobile photography workflow device performs the operations further comprising to synchronize the metadata update with one or more additional computing devices.

20. The computer-readable storage memory as recited in claim 16, wherein the mobile photography workflow device performs the operations further comprising to initiate an automatic download of the digital photos from the digital camera based on a communication link being established with the digital camera.
